(19) United States
(12) Patent Application Publication
(10) Pub. No.: US 2022/0311317 A1
(43) Pub. Date: Sep. 29, 2022

(54) STATOR AND METHOD OF MANUFACTURING STATOR

(71) Applicant: HONDA MOTOR CO., LTD., Tokyo (JP)

(72) Inventors: Yosuke HONDA, Tokyo (JP); Takuro YOSHIMURA, Tokyo (JP); Takashi SUMIDA, Tokyo (JP)

(21) Appl. No.: 17/676,248

(22) Filed: Feb. 21, 2022

(30) Foreign Application Priority Data
Mar. 26, 2021 (JP) 2021-053255

(51) Int. Cl. H02K 15/085; H02K 3/12; H02K 1/16

(52) U.S. Cl. CPC H02K 15/085; H02K 3/12; H02K 1/16; H02K 2213/03

(57) ABSTRACT

A stator includes a stator core having a through hole and a plurality of slots, and a continuous wire coil that, is mounted in the stator core, wherein the continuous wire coil includes a conductor wire and has a plurality of straight portions inserted in the slots, and a coil end portion that connects ends of the straight portions adjacent to each other on an outer side in an axial direction of the stator core, the coil end portion has a top portion formed by folding the conductor wire in a radial direction, the top portion has a width W in a circumferential direction, and the width w satisfies the following condition:

W≤2πR/N

where,
R is an innermost diameter of continuous wire coil wound so that an outer diameter is smaller than an inner diameter of a through hole,
N is the number of slots.

This application is based on and claims the benefit of priority from Japanese Patent Application No. 2021-053255, filed on 26 Mar. 2021, the content of which is incorporated herein by reference.

### BACKGROUND OF THE INVENTION

### Field of the Invention

The present invention relates to a stator and a method of manufacturing the stator.

### Related Art

There has been conventionally known a stator in which coils are mounted in a stator core by inserting slot housed portions of the coils into slots in the stator core from an inside of the stator core (for example, see Patent Document 1).

The coil in the related art includes an offset portion in which a conductor wire forming the coil is bent in a radial direction, at a top portion of a coil end portion that connects ends of the respective slot housed portions that are adjacent to each other so that the end portions are formed substantially into an L shape. In the aforementioned related art, the width in a circumferential direction of the offset portion is set to a predetermined width so that the offset portions are not stacked in an axial direction of the stator, which prevents an increase in length in the axial direction of the coil end portion and prevents an increase in length in the axial direction of the stator.

Patent Document 1: Japanese Patent No. 6485548

### SUMMARY OF THE INVENTION

There is known a coil forming a top portion of a coil end portion by folding the conductor wire in the radial direction. Since the top portion has a width equal to or more than a width of the conductor wire due to folding of the conductor wire, the diameter of the coil cannot be reduced any more if the top portions of the respective coil end portions that are adjacent to each other in the circumferential direction interfere with each other when the coil is wound. This may make it impossible to wind the coil with a diameter smaller than an inner diameter of a through hole of the stator core.

The present invention has an object to provide a stator configured so that conductor wires are insertable into slots from a through hole in a stator core without causing interference between top portions of coil end portions formed by folding the conductor wires in a radial direction, and a method of manufacturing the stator.

(1) A stator according to the present invention is a stator (e.g., a stator 1, which will be described later) comprising: a stator core (e.g., a stator core 2, which will be described later) having a through hole (e.g., a through hole 20, which will be described later) and a plurality of slots (e.g., slots 22, which will be described later) that are open toward the through hole; and a continuous wire coil (e.g., a continuous wire coil 3, which will be described later) that is mounted in the stator core by being inserted into the slots from the through hole, wherein the continuous wire coil comprises a conductor wire (e.g., a conductor wire 30, which will be described later) and has a plurality of straight portions (e.g., straight portions 31, which will be described later) inserted in the slots, and a coil end portion (e.g., a coil end portion 32, which will be described later) that connects ends of the straight portions adjacent to each other on an outer side in an axial direction (e.g., a 2 direction, which will be described later) of the stator core, the coil end portion has a top portion (e.g., a top portion 33, which will be described later) formed by folding the conductor wire in a radial direction (e.g., a Y direction, which will be described later), the top portion has a width W in a circumferential direction (e.g., an X direction, which will be described later), and the width W satisfies the following condition:

W≤2πR/N

where,
R is an innermost diameter of continuous wire coil, wound so that an outer diameter is smaller than an inner diameter of a through hole,
N is the number of slots.

(2) A method of manufacturing a stator according to the present invention is a method of manufacturing a stator (e.g., a stator 1, which will be described later) including: a stator core (e.g., a stator core 2, which will be described later) having a through hole (e.g., a through hole 20, which will be described later) and a plurality of slots (e.g., slots 22, which will be described later) that are open toward the through hole; and a continuous wire coil (e.g., a continuous wire coil 3, which will be described later) that is mounted in the stator core by being inserted into the slots from the through hole, the method comprising a coil forming step of forming a conductor wire into a continuous wire coil (e.g., a conductor wire 30, which will be described later) having a plurality of straight portions (e.g., straight portions 31, which will be described later) to be inserted into the slots, and a coil end portion (e.g., a coil end portion 32, which will be described later) that connect ends of the respective straight portions adjacent to each other on an outer side in an axial direction (e.g., a Z direction, which will be described later) of the stator core, and a coil insertion step of inserting the continuous wire coil into the through hole, the continuous wire coil being wound with a diameter smaller than an inner diameter of the through hole, and inserting the straight portions into the slots, wherein in the coil forming step, a top portion (e.g., a top portion 33, which will be described later) of the coil end portion is formed by folding the conductor wire in a radial direction (e.g., a Y direction, which will be described later) and formed so as to have a width W in a circumferential direction (e.g., an X direction, which will be described later), the width W satisfying the following condition:

W≤2πR/N

where,
R is an innermost diameter of continuous wire coil wound so that an outer diameter is smaller than an inner diameter of a through hole,
N is the number of slots.

(3) In the method of manufacturing a stator according to (2) as described above, in the coil forming step, when a plurality of conductor wires are arranged in parallel to each other and are folded in the radial direction, a pitch in an arrangement direction between the conductor wires may be adjusted so that a width W in the circumferential direction of the top portion satisfies the aforementioned condition.

According to (1) described above, the width W in the circumferential direction of the top portion of the coil end portion satisfies the aforementioned condition, which makes it possible to prevent the top portions of the coil end portions from interfering with each other, the coil end portions being adjacent to each other in the circumferential direction, when the continuous wire coil is wound with a diameter smaller than an inner diameter of the through hole in the stator core. Therefore, there can be provided the stator configured so that the continuous wire coil in which the top portions of the coil end portions are formed by folding the conductor wires in the radial direction is insertable into the slots from the through hole in the stator core.

According to (2) described above, folding the conductor wires in the radial direction so that the width W in the circumferential direction of the top portion of the coil end portion satisfies the aforementioned condition enables the continuous wire coil to be wound with a diameter smaller than the inner diameter of the through hole in the stator core without causing the interference between the top portions of the coil end portions that are adjacent to each other in the circumferential direction. Therefore, there can be provided the method of manufacturing the stator configured so that the continuous wire coil in which the top portions of the coil end portions are formed by folding the conductor wires in the radial direction is insertable into the slots from the through hole in the stator core.

According to (3) described above, the width W in the circumferential direction of the top portion can be formed so as to satisfy the condition by adjusting the pitch in the arrangement direction between the conductor wires when the top portion of the coil end portion is formed by folding the conductor wires. Therefore, the continuous wire coil can be easily formed without causing the interference between the top portions of the coil end portions that, are adjacent to each other in the circumferential direction.

### BRIEF DESCRIPTION OF THE DRAWINGS

FIG. 1 is a perspective view illustrating an embodiment of a stator;

FIG. 2 is a perspective view illustrating a state in which a continuous wire coil in a wound state is to be inserted into a through hole of a stator core;

FIG. 3 is a front view illustrating the continuous wire coil;

FIG. 4 is a diagram illustrating a step of forming the continuous wire coil;

FIG. 5 is a cross-sectional view taken along line A-A in FIG. 4;

FIG. 6 is a diagram illustrating a forming step of the continuous wire coil;

FIG. 7 is a diagram illustrating a forming step of the continuous wire coil;

FIG. 8 is a perspective view illustrating a coil winding jig;

FIG. 9 is a plan view illustrating a state in which the continuous wire coil is wound around the coil winding jig;

FIG. 10 is a diagram illustrating in which the continuous wire coil wound around the coil winding jig is reduced in diameter;

FIG. 11 is a diagram illustrating a pitch between conductor wires before being adjusted so that a top of a coil end portion is reduced, in width;

FIG. 12 is a diagram illustrating a width of the top of the coil end portion formed by the pitch between the conductor wires illustrated in FIG. 11;

FIG. 13 is a diagram illustrating a pitch between conductor wires that is adjusted so that a top of a coil end portion is reduced in width;

FIG. 14 is a diagram illustrating a width of the top of the coil end portion formed by the pitch between the conductor wires illustrated in FIG. 13;

FIG. 15 is a cross-sectional view illustrating a state in which clamp members hold conductive wires before a pitch is adjusted so that a top of a coil end portion is reduced in width; and

FIG. 16 is a cross-sectional view illustrating a state in which the clamp members hold the conductive wires in which the pitch is adjusted so that the top portion of the coil end portion is reduced in width.

### DETAILED DESCRIPTION OF THE INVENTION

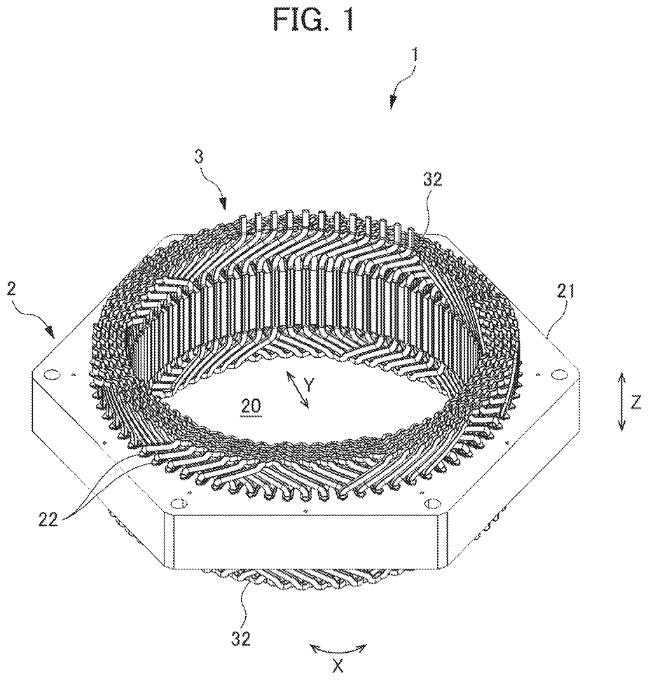

Hereinafter, embodiments according to the present invention will be described in detail with reference to the drawings. FIG. 1 is a perspective view illustrating an embodiment of a stator 1 of a rotating electrical machine. The stator 1 includes a stator a stator core 2 and a continuous wire coil 3 to be mounted in the stator core 2 to form an annular shape.

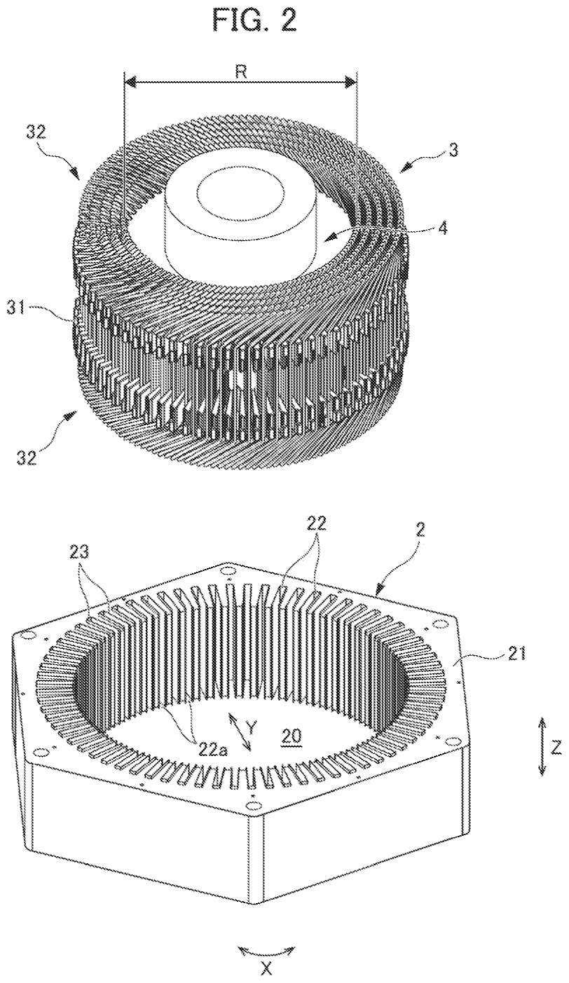

As illustrated in FIG. 2, the stator core 2 has an annular portion 21 formed of a stacked body in which a plurality of thin core plates are stacked, for example. The annular portion 21 has a through hole 20 formed at a center thereof, the through hole 20 passing through in an axial direction, and has a plurality of slots 22 passing through in the axial direction of the stator core 2. The slots 22 are arranged radially at constant intervals along a circumferential direction of the annular portion 21, and have openings 22a that are open toward the through hole 20. The stator core 2 of the present embodiment has 72 slots 22. Each of the slots 22 has insulating paper 23 inserted thereinto. Note that in the stator 1 and the stator core 2, as indicated by arrows in FIGS. 1 and 2, an X direction in which the slots 22 are arranged indicates the circumferential direction, a Y direction along a radial direction from a center of the through hole 20 indicates the radial direction, and a Z direction perpendicular to the Y direction indicates the axial direction.

The continuous wire coil 3 is wound with a diameter smaller than an inner diameter of the through hole 20 in the stator core 2 so as to be arranged in the through hole 20, and Is inserted into the slots 22 from the inside of the through hole 20 to thereby be mounted in the stator core 2 so as to form an annular shape. More specifically, as illustrated in FIG. 2, the continuous wire coil 3 is inserted into the through hole 20 in the stator core 2 in a state of being multiply wound around the outer periphery of a coil winding jig 4 to form an annular shape.

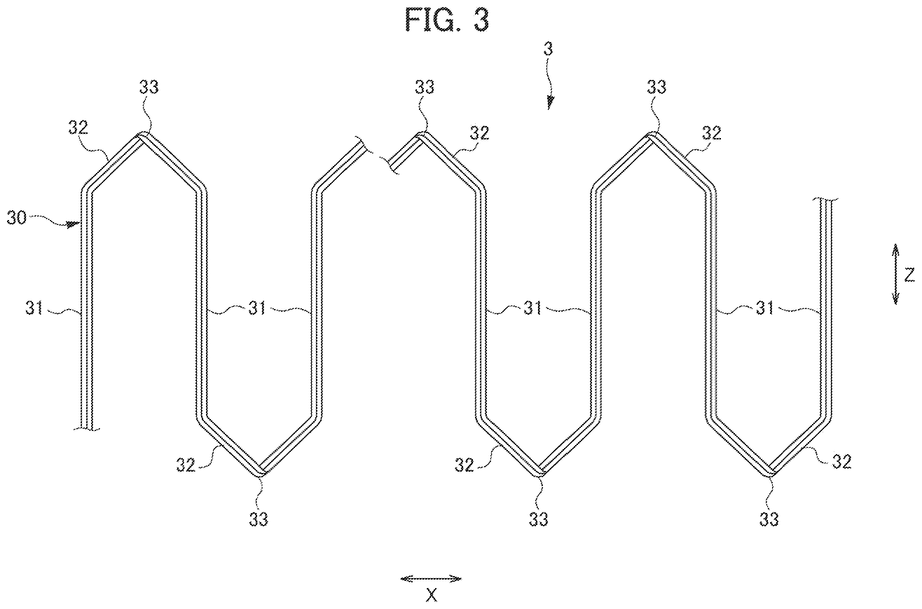

Here, the continuous wire coil 3 will be described with reference to FIGS. 3 to 7. The continuous wire coil 3 is a long belt-shaped coil that is formed by bending a plurality of conductor wires 30. The continuous wire coil 3 is continuous along the circumferential direction of the stator core 2. As illustrated in FIG. 5, the conductor wire 30 of the present embodiment includes two rectangular wires 30a and 30a that are arranged along the circumferential direction of the stator core 2. The rectangular wires 30a and 30a are made of a highly conductive metal such as copper, or aluminum, for example.

As illustrated in FIG. 3, the conductor wire 30 of the continuous wire coil 3 is bent to form a wavy shape having a plurality of straight portions 31 and a plurality of coil end portions 32. The straight portions 31 each are a site to be inserted into the corresponding slot 22 in the stator core 2, extend substantially linearly, and are arranged in parallel to each other at certain intervals. A length in an extending direction of the straight portion 31 is approximately equal to a length in the axial direction of the slot 22 in stator core 2. The coil end portions 32 each are arranged at a position closer to a side end of the continuous wire coil 3 from the corresponding straight portion 31, and alternately connect one end of each of straight portions 31 that are adjacent to each other, and the other end of each thereof to form a mountain shape, the one end and the other end protruding outward in the axial direction of the stator core 2 from the corresponding slot 22.

In the continuous wire coil 3 of the present embodiment, each of the coil end portions 32 of the conductor wire 30 has a top portion 33 formed by folding the conductor wire 30 in the radial direction (a vertical direction to a paper surface of FIG. 3) of the stator 1. The top portion 33 is a site arranged at an outermost position in the axial direction of the stator core 2 in the corresponding mountain-shaped coil end portion 32.

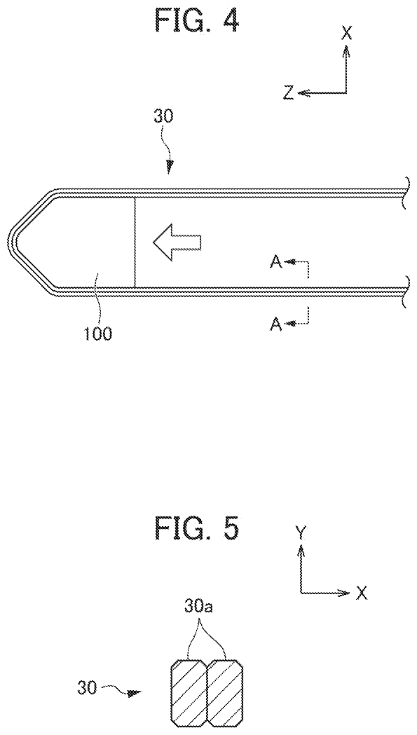

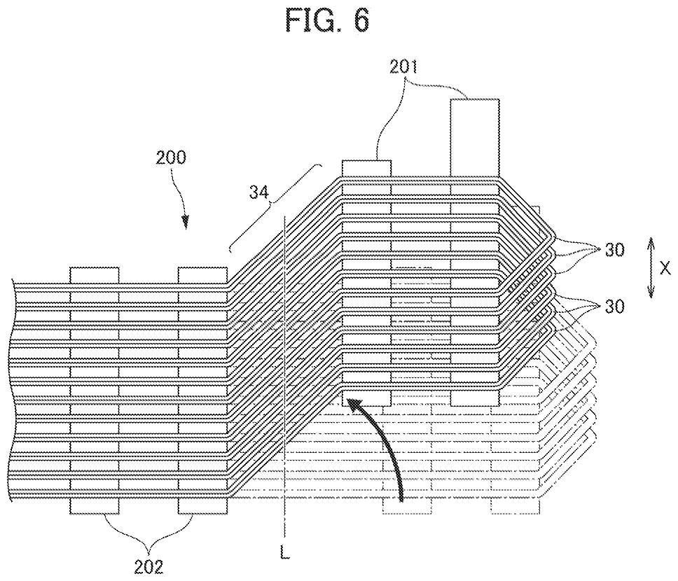

Such a continuous wire coil 3 is formed as follows, for example. The conductor wire 30 is first cut to have a predetermined length, and then is bent to form a substantial U shape at a substantially center portion in the extending direction oi the conductor wire 30, using an extracting tool 100 that moves in a direction indicated by a white hollow arrow, as illustrated in FIG. 4. As illustrated in FIG. 6, six conductor wires 30 each or which is bent to form a substantial U shape are arranged in parallel to each other so that distal ends having the substantial U shape are arranged in the same direction, and are held by clamp portions 201 and 202 of a forming machine 200.

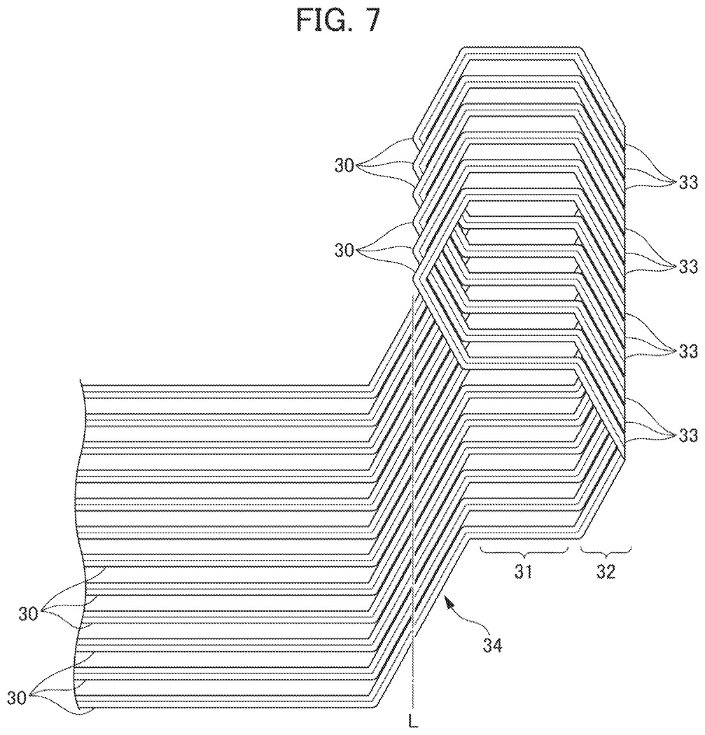

The clamp portions 201 and 202 are moved so as to be offset relative to each other along the arrangement direction of the six conductor wires 30 to thereby form an inclined portion 34 in a site between the clamp portions 201 and 202 of the conductor wire 30. Then, one clamp portion 201 is moved to face the other clamp portion 202 with respect to a folding line L set in the inclined portion 34 of the conductor wire 30, to thereby form a first coil end portion 32 in which the conductor wire 30 is folded in the inclined portion 34. The top portions 33 formed by folding the respective conductor wires 30 are formed in the formed coil end portion 32, as illustrated in FIG. 7.

Then, a long belt-shaped coil in which six continuous wire coils 3 are arranged to form the shape illustrated in FIG. 3 is formed (a coil forming step) by repeating a step of forming an inclined portion 34 in the conductor wires 30 and a step of folding the inclined portion 34 along the folding line L a plurality of times in the same manner, as illustrated in FIG. 7.

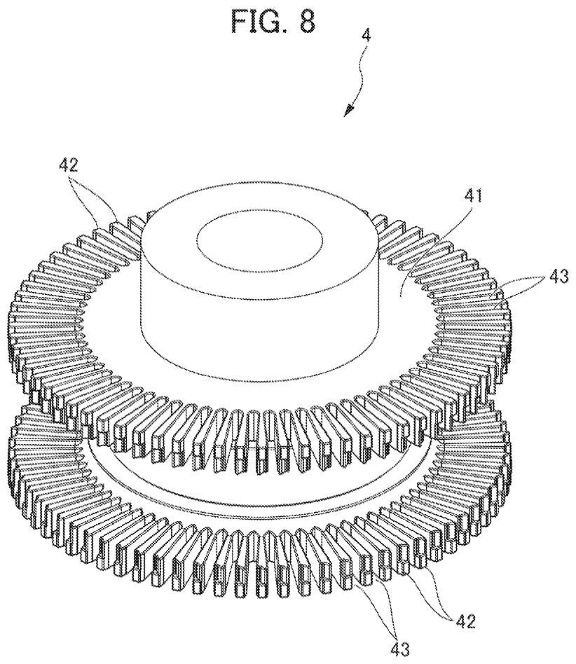

The coil winding jig 4 has a substantially cylindrical jig main body 42, a plurality of comb tooth portions 42 protruding radially around the outer periphery of the jig main body 41, and a plurality of comb-shaped grooves 43 formed between the comb tooth portions 42 that are adjacent to each other in the circumferential direction, as illustrated in FIG. 8. The comb tooth portions 42 and the comb tooth shaped grooves 43 are provided to each end in the axial direction of the jig main body 41. The comb tooth portions 42 and the comb tooth shaped grooves 43 at each end of the jig main body 41 have the same phase in the axial direction. The number of comb tooth shaped grooves 43 arranged in the circumferential direction of the jig main body 41 corresponds to the number of slots 22 provided in the stator core 2. Accordingly, the coil winding jig 4 of the present embodiment has 72 comb tooth shaped grooves 43. The coil winding jig 4 is formed so that the outer diameter of the coil winding jig 4 defined by the positions of the distal ends of the respective comb tooth portions 42 is smaller than the inner diameter of the stator core 2, whereby the coil winding jig 4 can be inserted into the inside of the annular portion 21 of the stator core 2.

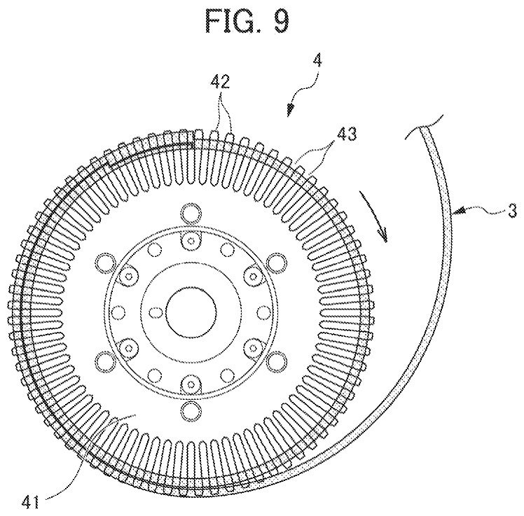

Before the coil winding jig 4 is inserted into the through hole 20 in the stator core 2, the continuous wire coil 3 is multiply wound by sequentially inserting the straight portions 31 oi the continuous wire coil 3 into the respective comb tooth shaped grooves 43 from the outside, as illustrated in FIG. 9. Thus, the coil winding jig 4 is formed in which the continuous wire coil 3 is wound to form the annular shape having a diameter smaller than the inner diameter of the through hole 20 in the stator core 2, as illustrated in FIG. 2.

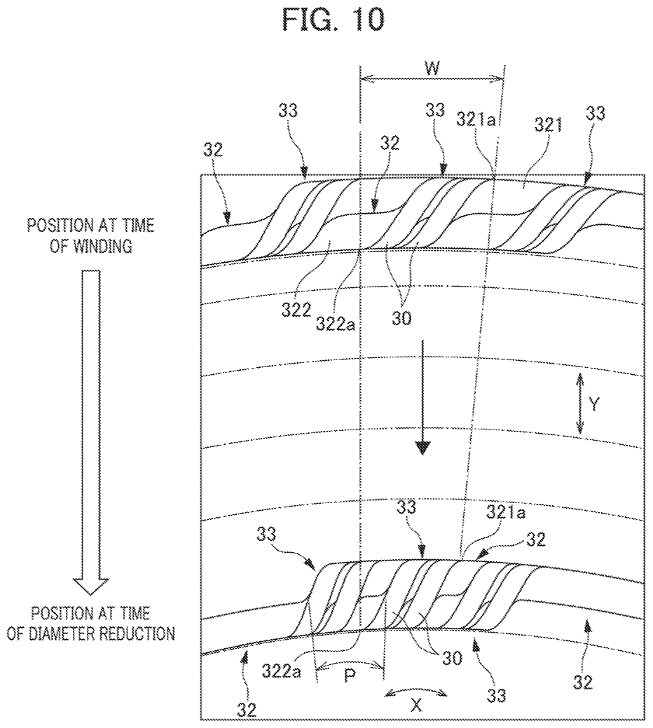

The straight portion 31 of the continuous wire coil 3 wound multiply around the coil winding jig 4 moves in the corresponding comb tooth shaped groove 43 from a position at the time of winding that is outside in the radial direction of the coil winding jig 4 toward a position at the time of diameter reduction that is inside in the radial direction of the coil winding jig 4 as the winding proceeds, as illustrated in FIG. 10. As a result, the straight portions 31 and 31 of the continuous wire coil 3 are guided into the comb tooth shaped grooves 43 while the coil end portions 32 are being deformed so that the top portions 33 protrude, whereby the intervals between the straight portions 31 and 31 that are adjacent to each other are gradually reduced. When the intervals between the straight portions 31 and 31 that are adjacent to each other are reduced, the intervals between the top portions 33 and 33 of the coil end portions 32 that are adjacent to each other in the circumferential direction are also reduced gradually.

Here, when the width in the circumferential direction of the top portion 33 of the coil end portion 32 is referred to as W, the innermost diameter of the continuous wire coil 3 that is wound so that the outer diameter thereof is smaller than the inner diameter of the through hole 20 is referred to as R (see FIG. 2), and the number of slots 22 is referred to as N, the following relationship is satisfied.

W≤2πR/N

The width W in the circumferential direction (the X direction) of the top portion 33 is a width of a region in which the deformation of the folded conductor wires 30 extends in the circumferential direction of the top portion 33 with the top portion 33 of the coil end portion 32 as a boundary, as illustrated in FIG. 10. This is because a contact between the deformation regions of the conductor wires 30 is caused in the circumferential direction when the continuous wire coil 3 is reduced in diameter. More specifically, the coil end portion 32 has one coil end portion 321 that is arranged outside in the radial direction (the Y direction) and the other coil end portion 322 that is arranged inside in the radial, direction (the Y direction), by folding the conductor wires 30. The width when the top portion 33 is viewed from the radial direction is referred to as the width W in the circumferential direction of the top portion 33, the width having, as both ends thereof, a site 321a in which the outside in the circumferential direction of the one coil end portion 321 is deformed due to folding of the conductor wires 30 and a site 322a in which the outside in the circumferential direction of the other coil end portion 322 is deformed due to folding of the conductor wires 30 with the top portion 33 as a boundary.

In the case where the width W of the top portion 33 satisfies the aforementioned relationship, the width W of the top portion 33 is narrower than an arrangement pitch on the innermost circumference side between the comb tooth shaped grooves 43 of the coil winding jig 4, whereby the top portions 33 and 33 of the coil end portions 32 and 32 that are adjacent to each other in the circumferential direction can be prevented from interfering with each other in the innermost circumference in the wound state even when the continuous wire coil 3 is wound around the coil winding jig 4 so that the outer diameter of the continuous wire coil 3 in a wound state is smaller than the inner diameter of the through hole 20 in the stator core 2.

Note that as illustrated in FIG. 10, in the innermost circumference side of the continuous wire coil 3 wound so that the outer diameter is smaller than the inner diameter of the through hole 20, the width W of the top portion 33 satisfies the relationship of R≤P when the pitch of the conductor wires 30 of the continuous wire coil 3 along the circumferential direction (the X direction) is referred to as P.

Examples of a method of forming the continuous wire coil 3 so that the width W of the top portion 33 of the coil end portion 32 satisfies the aforementioned relationship includes a method of appropriately adjusting the pitch between the conductor wires 30 and 30 that are adjacent to each other, when the conductor wires 30 are folded along the folding line L, as illustrated in FIGS. 6 and 7.

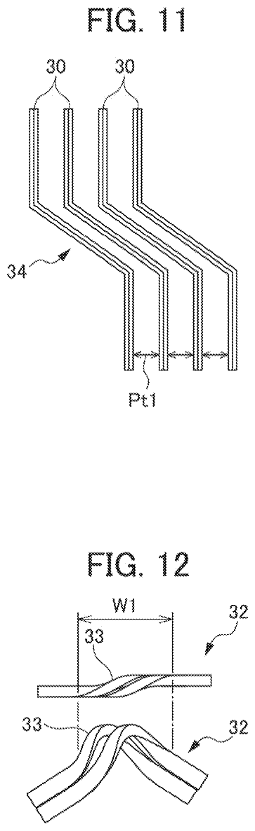

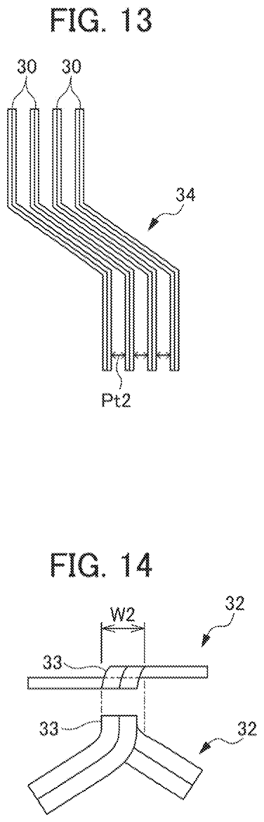

More specifically, for example, as illustrated in FIG. 12, a top portion 33 having a width W1 is formed in the coil end portion 32 formed when a plurality of conductor wires 30 are folded in a state in which the conductor wires 30 are arranged in parallel to each other at a predetermined pitch Pt1 in the arrangement direction as illustrated in FIG. 11. In contrast, as illustrated in FIG. 14, a top portion 33 having a width W2 is formed in the coil end portion 32 formed when a plurality of conductor wires 30 are folded in a state in which the conductor wires 30 are arranged in parallel to each other at a predetermined pitch Pt2 satisfying Pt1>Pt2 in the arrangement direction as illustrated in FIG. 13. At this time, the width W2 satisfies W1>W2. This is because the width W of the top portion 33 after being folded is formed to be narrow, since it becomes difficult, to move the inclined portion 34 of the conductor wires 30 in the arrangement direction when being folded as the pitch between the conductor wires 30 before being folded is reduced.

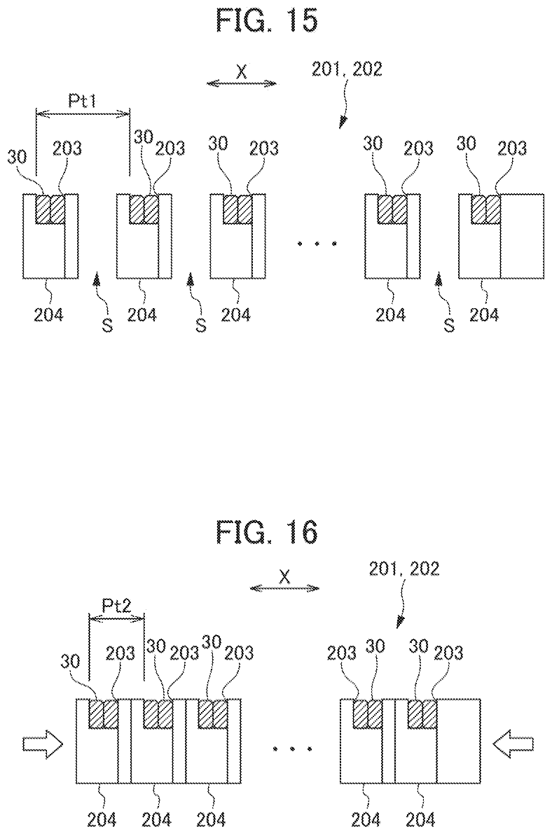

The pitch Pt between the conductor wires 30 can be adjusted using the clamp portions 201 and 202 illustrated in FIG. 15, for example. The clamp portions 201 and 202 are formed by a plurality of blocks 204 each having a groove 203 in which one conductor wire 30 can be held. A gap S is provided between the blocks 204 and 204 that are adjacent to each other so that an interval between the blocks 204 and 204 can be adjusted. The interval between the blocks 204 and 204 that are adjacent to each other is adjusted when each block 204 is moved in the arrangement direction, whereby the pitch Pt between the conductor wires 30 is adjusted. Accordingly, the width W of the top portion 33 after being folded can be reduced by folding the plurality of conductor wires 30 using the clamp portions 201 and 202 in which the blocks 204 are arranged so that the plurality of conductor wires 30 are arranged at the pitch Pt2 as illustrated in FIG. 16 as compared with using the clamp portions 201 and 202 in which the blocks 204 are arranged so that the plurality of conductor wires 30 are arranged at a pitch Pt1 as illustrated in FIG. 15.

The coil winding jig 4 around which the continuous wire coil 3 formed as described above is wound to form an annular shape with a diameter smaller than the inner diameter of the through hole 20 in the stator core 2 is inserted into the through hole 20 in the stator core 2 as illustrated in FIG. 2, and then the coil end portions 32 of. the annular continuous wire coil 3 increases in diameter from the inside to the outside in the radial direction by the extracting tool (not illustrated). In this way, the continuous wire coil 3 expands, and the straight portions 31 are inserted into the slots 22 in the stator core 2 from the through hole 20 side (a coil insertion step). As a result, the stator 1 illustrated in FIG. 1 is completed in which the continuous wire coil 3 is mounted in the stator core 2 so as to form an annular shape.

As described above, the stator 1 of the present embodiment is a stator including the stator core 2 having the through hole 20 and the plurality of slots 22 that are open toward the through hole 20, and the continuous wire coil 3 to be mounted in the stator core 2 by being inserted into the slots 22 from the through hole 20. The continuous wire coil 3 is formed by the conductor wires 30, and has the plurality of straight portions 31 to be inserted into the slots 22, and the coil end portions 32 that connect ends of the respective straight portions 31 and 31 that are adjacent to each other in the outside in the axial direction (the 2 direction) of the stator core 2, arid the coil end portion 32 has the top portion 33 in which the conductor wires 30 are folded in the radial direction (the Y direction). The width W in the circumferential direction (the X direction) of the top portion 33 satisfies the following condition:

W≤2πR/N

where,
R: innermost diameter of the continuous wire coil 3 wound so that the outer diameter is smaller than the inner diameter of the through hole 20,
N: the number of slots 22.

This can prevent the top portions 33 and 33 of the coil end portions 32 and 32 from interfering with each other, the coil end portions 32 and 32 being adjacent to each other in the circumferential direction, when the continuous wire coil 3 is wound with a diameter smaller than the inner diameter of the through hole 20 in the stator core 2. Therefore, there can be provided the stator 1 configured so that the continuous wire coil 3 in which the top portions 33 of the coil end portions 32 are formed by folding the conductor wires 30 in the radial direction is insertable into the slots 22 from the through hole 20 in the stator core 2.

A method of manufacturing the stator 1 of the present embodiment is a method of manufacturing a stator including the stator core 2 having the through hole 20 and the plurality of slots 22 that are open toward the through hole 20, and the continuous wire coil 3 to be mounted in the stator core 2 by being inserted into the slots 22 from the through hole 20. The method of manufacturing the stator 1 includes a coil forming step of forming the continuous wire coil 3 by the conductor wires 30, the continuous wire coil 3 having the plurality of straight portions 31 to be inserted into the slots 22, and the coil end portions 32 that connect the ends of the respective straight portions 31 and 31 that are adjacent to each other in the outside in the axial direction (the Z direction) of the stator core 2, and a coil insertion step of inserting the continuous wire coil 3 into the through hole 20, the continuous wire coil 3 being wound with a diameter smaller than the inner diameter of the through hole 20, and inserting the straight portions 31 into the slots 22. In the coil forming step, the top portion 33 of the coil end portion 32 is formed by folding the conductor wires 30 in the radial direction (the Y direction), and the width W in the circumferential direction (the X direction) of the top portion 33 Is formed to satisfy the following condition:

W≤2πR/N

where,
R: innermost diameter of the continuous wire coil 3 wound so that the outer diameter is smaller than the inner diameter of the through hole 20,
N: the number of slots 22.

This enables the continuous wire coil 3 to be wound with a diameter smaller than the inner diameter of the through hole 20 in the stator core 2 without causing the interference between the top portions 33 and 33 of the coil end portions 32 and 32 that are adjacent to each other in the circumferential direction. Therefore, there can be provided the method of manufacturing the stator 1 configured so that the continuous wire coil 3 in which the top portions 33 of the coil end portions 32 are formed by folding the conductor wires 30 in the radial direction is insertable into the slots 22 from the through hole 20 in the stator core 2.

In the coil forming step of the present embodiment, when a plurality of conductor wires 30 are arranged in parallel to each other and are folded in the radial direction (the Y direction), the pitch Pt in the arrangement direction between the conductor wires 30 is adjusted so that the width w in the circumferential direction (the X direction) of the top portion 33 satisfies the aforementioned condition.

Accordingly, the width W in the circumferential direction of the top portion 33 of the coil end portion 32 can be formed to satisfy the condition, which makes it possible to easily form the continuous wire coil 3 without causing the interference between the top portions 33 and 33 of the coil end portions 32 and 32 that are adjacent to each other in the circumferential direction.

### EXPLANATION OF REFERENCE NUMERALS

1 Stator

2 Stator core

20 Through hole

22 Slot

3 Continuous wire coil

30 Conductor wire

31 Straight portion

32 Coil end portion

33 Top portion

What is claimed is:

1. A stator comprising:
a stator core having a through hole and a plurality of slots that, are open toward the through hole; and
a continuous wire coil that is mounted in the stator core by being inserted into the slots from the through hole,
wherein the continuous wire coil comprises a conductor wire and has a plurality of straight portions inserted in the slots and a coil end portion that connects ends of the straight portions adjacent to each other on an outer side in an axial direction of the stator core,
the coil end portion has a top portion formed by folding the conductor wire in a radial direction,
the top portion has a width W in a circumferential direction, and the width W satisfies the following condition:
W≤2πR/N
where,
R is an innermost diameter of continuous wire coil wound so that an outer diameter is smaller than an inner diameter of a through hole,
N is the number of slots.

2. A method of manufacturing a stator including a stator core having a through hole and a plurality of slots that are open toward the through hole; and
a continuous wire coil that is mounted in the stator core by being inserted into the slots from the through hole, the method comprising:
a coil forming step of forming a conductor wire into a continuous wire coil having a plurality of straight portions to be inserted into slots and a coil end portion that connect ends of the respective straight portions adjacent to each other on an outer side in an axial direction of the stator core; and
a coil insertion step of inserting the continuous wire coil into the through hole, the continuous wire coil being wound with a diameter smaller than an inner diameter of the through hole, and inserting the straight portions into the slots,
wherein in the coil forming step, a top portion of the coil end portion is formed by folding the conductor wire in a radial direction and formed so as to have a width W in a circumferential direction, the width W satisfying the following condition:
W≤2πR/N
where,
R is an innermost diameter of continuous wire coil wound so that an outer diameter is smaller than an inner diameter of a through hole,
N is the number of slots.

3. The method of manufacturing a stator according to claim 2, wherein in the coil forming step, when a plurality of conductor wires are arranged in parallel to each other and are folded in the radial direction, a pitch in an arrangement direction between the conductor wires is adjusted so that a width W in the circumferential direction of the top portion satisfies the aforementioned condition.
